(19) United States
(12) Patent Application Publication
(10) Pub. No.: US 2005/0149978 A1
(43) Pub. Date: Jul. 7, 2005

(54) Still image capture device and digital/analog tuner device comprising the same

(75) Inventors: Shusuke Narita, Daito-shi (JP); Toshihiro Takagi, Daito-shi (JP); Tatsuo Miyagawa, Daito-shi (JP); Yasuhiro Inui, Daito-shi (JP); Takahiro Katayama, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/028,625

(22) Filed: Jan. 5, 2005

(30) Foreign Application Priority Data
Jan. 6, 2004 (JP) 2004-001084

(51) Int. Cl. H04N 5/225

(52) U.S. Cl. 725/105

(57) ABSTRACT

A digital/analog tuner device comprising a still image capture device stores, as the captured image, a video image of a video signal with VBI (Vertical Blanking Interval) portions of the video signal being removed, when storing a captured image, and also stores aspect ratio information of the captured image. For displaying on a television receiver the captured image with the VBI portions being removed, blank portions in accordance with the aspect ratio information are added to the captured image for output. This makes it possible to prevent the generation of e.g. noises due to the VBI portions contained in video signals, and prevent the deformation of captured images due to the loss of the aspect ratio information in capturing the images.

### BACKGROUND OF THE INVENTION

1. Field of the Invention

The present invention relates to a still image capture device to store, as still images, video signals contained in digital/analog broadcast signals, and to a digital/analog tuner device comprising the still image capture device.

2. Description of the Related Art

A still image capture device as well as a digital/analog tuner device comprising the same is known in the prior art, which stores a moving image for one frame displayed on a television receiver as a still image (hereafter referred to as “captured image”). In the case of analog broadcast, there is a problem that such a still image capture device sometimes captures VBI (Vertical Blanking Interval) portions as noise in storing captured images. For digital broadcast as well, there are cases where television programs based on analog broadcast are digitally converted for broadcast. In such cases, there is a possibility that video images to be displayed contain VBI portions of original television programs as images. When such video images are captured and displayed on a reduced screen, the VBI portions become too conspicuous and do not look good.

There is another problem as well. In the case of digital broadcast, video images of 704×480 pixels, for example, are broadcast. Such video images have an aspect ratio of either 16:9 or 4:3 which is contained as data in streams of digital broadcast. According to a conventional digital/analog tuner device, it is possible to prevent video image deformation for output by adding blank portions to the left and right as well as the top and bottom of each image in accordance with the aspect ratio information contained in the broadcast and the setting of display mode of the television receiver. However, in the case where such video images are stored as captured images, the aspect ratio data in the streams are lost, leaving only the information that the video images are of 704×480 pixels. Accordingly, when the captured images are displayed on a television receiver with an aspect ratio different from the above-described aspect ratio information, it results that the captured images displayed on a display screen of the television receiver become deformed.

Besides, some still image capture devices are known to capture video images. For example, a conventional still image capture device continuously captures moving image data as still images at given time intervals while the moving image data are input and displayed on a display screen of a television receiver. It is so designed that a user can set time intervals to temporarily store the images in a memory device and can also set the capacity of the memory device, so that the user can securely capture video images which the user desires to capture (refer to e.g. Japanese Laid-open Patent Publication 2001-54053).

A further conventional still image capture device stores images, in a delay memory, from a current image of a frame being displayed on a display screen back to an image preceding the current image by a few frames. When a user presses a capture button, the still image capture device captures, in a hard disk, all the images stored in the delay memory. It is so designed that the still image capture device calculates a differential value between the frames, and writes or stores a new image in the delay memory only if the differential value is larger than a predetermined value, whereby the capacity of the delay memory can be reduced, and the user can easily capture video images which the user desires to capture (refer to e.g. Japanese Laid-open Patent Publication Hei 11-98452).

However, none of the still image capture devices disclosed in the two references can prevent generation of e.g. noises due to the VBI portions contained in the video signals, or prevent deformation of captured images due to the loss of the aspect ratio information in capturing the images, although they can facilitate the user to capture video images which the user desires to capture.

### SUMMARY OF THE INVENTION

An object of the present invention is to provide a still image capture device and a digital/analog tuner device comprising the same, which can prevent the generation of e.g. noises due to the VBI portions contained in the video signals, and prevent the deformation of captured images due to the loss of the aspect ratio information in capturing the images.

According to a first aspect of the present invention, this object is achieved by a still image capture device to store, as a captured image, a video signal for one frame input thereto, wherein when storing the captured image, the still image capture device removes VBI (Vertical Blanking Interval) portions of the video signal in accordance with resolution and kind of broadcast of the video signal.

According to this first aspect of the present invention, the VBI portions of the video signal are removed in storing the video signal as a captured image, so that the VBI portions can be prevented from being captured as noise in the captured image.

Preferably, the still image capture device of the first aspect of the present invention is applied to a digital/analog tuner device comprising the still image capture device according to claim 1 and further comprising: a receiving means for receiving digital/analog broadcast signals; a decoder for extracting video signals from the digital/analog broadcast signals received by the receiving means, in which the still image capture device stores, as the captured image, a video signal for one frame extracted by the decoder; and an output means for outputting, to a display means, the video signal extracted by the decoder and the captured image stored by the still image capture device, wherein when storing the captured image, the still image capture device stores aspect ratio information of the captured image, wherein when outputting the captured image to the display means, the output means outputs the captured image with the VBI portions being removed, and wherein in the case where the captured image is displayed on the display means with an aspect ratio different from the aspect ratio information, the output means adds, to the captured image for output, blank portions corresponding to the aspect ratio information so as to prevent deformation of the captured image.

According to this preferred mode, the VBI portions of the video signal are removed in storing the video signal as a captured image, and the captured image with the VBI portions being removed is output to the display means, so that the VBI portions can be prevented from being captured as noise in the captured image for display. Furthermore, the aspect ratio information of the captured image together with the captured image is stored in storing the video signal as the captured image, and blank portions corresponding to the aspect ratio information are added to the captured image in outputting the captured image to the display means so as to prevent deformation of the captured image, so that the captured image can be displayed on the display means without being deformed.

According to a second aspect of the present invention, the above object is achieved by a digital/analog tuner device comprising: a receiving means for receiving digital/analog broadcast signals; a decoder for extracting video signals from the digital/analog broadcast signals received by the receiving means; a still image capture device to store, as a captured image, a video signal for one frame extracted by the decoder; and an output means for outputting, to a display means, the video signal extracted by the decoder and the captured image stored by the still image capture device, wherein when storing the captured image, the still image capture device stores aspect ratio information of the captured image together with the captured image, wherein when outputting the captured image to the display means in the case where the captured image is displayed on the display means with an aspect ratio different from the aspect ratio information, the output means adds, to the captured image for output, blank portions corresponding to the aspect ratio information so as to prevent deformation of the captured image.

According to this second aspect of the present invention, the aspect ratio information of the captured image is stored in storing the captured image, and blank portions corresponding to the aspect ratio information are added to the captured image in outputting the captured image to the display means, so that the captured image can be displayed on the display means without being deformed.

According to a third aspect of the present invention, the above object is achieved by a digital/analog tuner device comprising: a receiving means for receiving digital/analog broadcast signals; a decoder for extracting video signals and EPG (Electronic Program Guide) information from the digital/analog broadcast signals received by the receiving means; a still image capture device to store, as a captured image, a video signal for one frame extracted by the decoder; and an output means for outputting, to a display means, the video signal extracted by the decoder and the captured image stored by the still image capture device, wherein when storing the captured image, the still image capture device stores the EPG information for the captured image together with the captured image, and wherein when outputting the captured image to the display means, the output means superimposes the EPG information on the captured image for output so as to hide VBI portions contained in the video signal.

According to this third aspect of the present invention, the EPG information is superimposed on the captured image for output in outputting the captured image to the display means so as to hide VBI portions contained in the video signal, so that the VBI portions are not displayed as noise. Furthermore, the EPG information is output together with the captured image, so that it becomes possible to easily identify which program has been captured.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic electrical block diagram showing a digital/analog tuner device according to a first embodiment of the present invention;

FIG. 2A is a schematic view showing a video signal of analog broadcast for explaining it, and FIG. 2B is a schematic captured image according to prior art which is stored with VBI portions being stored as is, while FIG. 2C is a schematic captured image according to the first embodiment of the present invention which is stored with the VBI portions being removed;

FIG. 3A is a schematic view showing the case of capturing a video signal of digital broadcast with 480 line resolution, while FIG. 3B is a schematic view showing the case of capturing a video signal of digital broadcast with 1080 line resolution;

FIG. 4 is a schematic view showing examples of captured images with different aspect ratios of video signals as displayed according to the prior art;

FIG. 5 is a schematic view showing examples of captured images with different aspect ratios of video signals as displayed according to the first embodiment of the present invention; and

FIG. 6A is a schematic view showing a display screen displaying a captured image according to the prior art in which the VBI portions are displayed as is, while FIG. 6B is a schematic view showing a display screen displaying a captured image according to a second embodiment of the present invention in which EPG information is superimposed on the VBI portions.

### DESCRIPTION OF THE PREFERRED EMBODIMENTS

The best modes and preferred embodiments of the present invention will be described hereinafter with reference to the annexed drawings. The specific embodiments described are not intended to cover the entire scope of the present invention, and hence the present invention is not limited to only the specific embodiment.

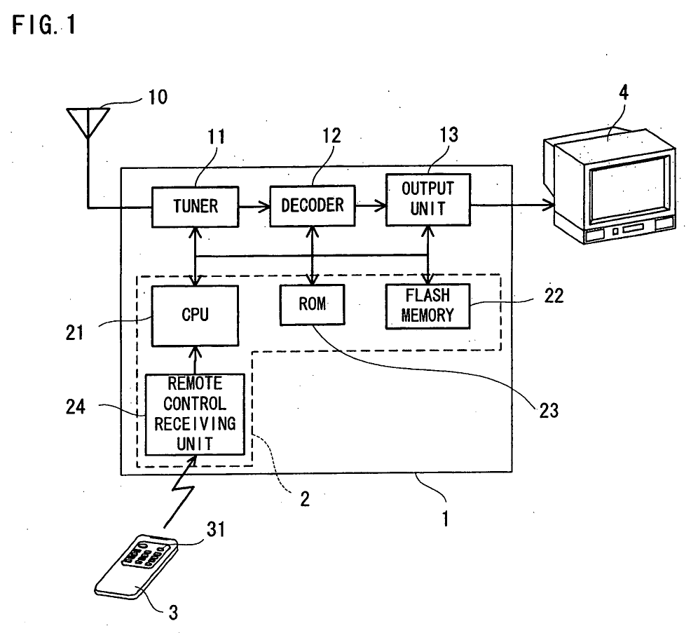

Referring to FIG. 1 through FIG. 5, a still image capture device as well as a digital/analog tuner device comprising the same according to a first embodiment of the present invention will be described, using a STB (Set-Top Box) as an example. As shown in FIG. 1, the STB (digital/analog tuner device) 1 is such a device that receives, through an antenna 10, digital/analog broadcast signals transmitted from broadcast stations, and extracts video signals and audio signals from the digital/analog broadcast signals, and further outputs them to a television receiver 4.

The STB 1 comprises: a tuner (receiving means) 11 to receive digital/analog broadcast signals through the antenna 10; a decoder 12 to extract video signals from the digital/analog broadcast signals received by the tuner 11; a still image capture device 2 to store, as a captured image, a video signal for one frame as extracted by the decoder 12; and an output unit 13 (output means) for outputting, to the television receiver 4, the video signal extracted by the decoder 12 and the captured image stored by the still image capture device 2. The still image capture device 2 comprises: a CPU (Central Processing Unit) 21 to control the entire STB including the still image capture device 2; a flash memory 22 to store a captured image and so on; a ROM (Read-Only Memory) 23 to store an operating program of the CPU 21; and a remote control receiving unit 24.

When a channel of digital broadcast is selected by a remote control 3, the decoder 12 demodulates the received signals received by the tuner 11, and generates transport stream signals including signals such as digital compression-coded video signals, audio signals and EPG (Electronic Program Guide) information of television programs. The decoder 12 separates and extracts the video signals and the audio signals of the television program of the channel selected by the remote control 3, and decodes these signals into signals before digital compression-coded, and further outputs such decoded signals to the television receiver 4 through the output unit 13. The decoder 12 furthermore extracts EPG information from the transport stream signals, and outputs the EPG information to the flash memory 22 and so on.

On the other hand, when a channel of analog broadcast is selected by the remote control 3, the decoder 12 demodulates the received signals received by the tuner 11, and extracts video signals and audio signals of the television program of the channel selected by the remote control 3, and further outputs such video signals and audio signals to the television receiver 4 through the output unit 13. The output unit 13 comprises an OSD (On-Screen Display) circuit, and superimposes, on the video signals output from the decoder 12 or the flash memory 22, signals to display various information such as EPG information on the screen, and further outputs the thus superimposed signals to the television receiver 4.

When a channel of digital broadcast is selected by the remote control 3, the CPU 21 instructs the tuner 11 to receive broadcast signals of the selected channel in response to the signal from the remote control receiving unit 24, and also instructs the decoder 12 to separate, extract and decode video signals and audio signals of the selected channel. On the other hand, when a channel of analog broadcast is selected by the remote control 3, the CPU 21 instructs the tuner 11 to receive broadcast signals of the selected channel in response to the signal from the remote control receiving unit 24, and also instructs the decoder 12 to demodulate the video signals and the audio signals. Furthermore, the CPU 21 controls captured image storing operations for the flash memory 22 to store a captured image in response to operation by a user to operate a capture button 31 of the remote control 3. For storing the captured image in the flash memory 22, the captured image is compressed using e.g. the JPEG (Joint Photographic Experts Group) format, and is then stored in the flash memory 22.

The flash memory 22 stores a captured image and the aspect ratio information of the captured image as well as the EPG information. The flash memory 22 comprises e.g. an EEPROM (Electrically Erasable Programmable Read-Only Memory), and the captured image and the like stored in the flash memory 22 are stored therein even if the power is off.

When a user operates the capture button 31 for capturing a video image as a still image which the user desires, the remote control 3 sends, to the remote control receiving unit 24, infrared signals in accordance with the operation of the capture button 31. The remote control receiving unit 24 receives the signals sent from the remote control 3, and outputs the received signals to the CPU 21.

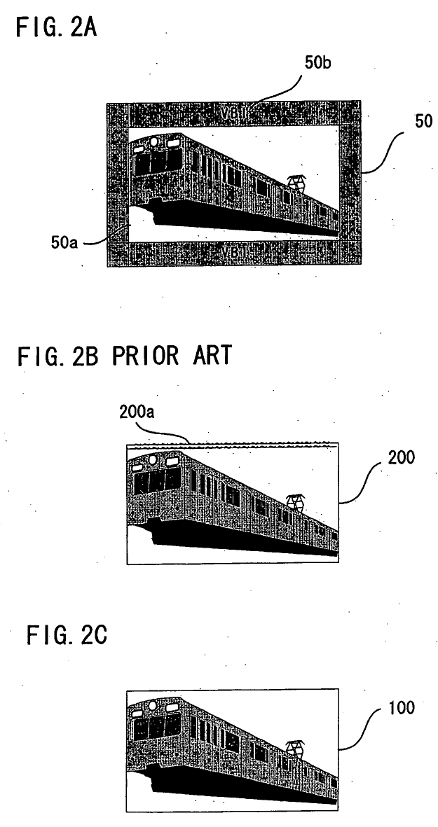

The following describes means for preventing the generation of e.g. noises due to the VBI portions contained in video signals. The locations where the VBI portions are assumed to exist vary with the kinds of resolutions of the video signals and with broadcasts as to whether they are analog, digital 480i, digital 480p, digital 720p, digital 1080i or others, where “i” stands for “interlaced”, and “p” for “progressive”. Thus, first of all, the case of capturing a video signal of analog broadcast will be described below with reference to FIG. 2A, FIG. 2B and FIG. 2C.

As shown in FIG. 2A, there exists VBI portions 50b, as well as an image 50a, in a video signal 50 of analog broadcast. A conventional still image capture device captures such video signal 50 as is, so that as shown in FIG. 2B, the VBI portions 50b are stored, as is, and sometimes captured as noise 200a in a captured image 200. In contrast, the STB 1 according to the present embodiment removes the VBI portions 50b of the video signal in storing it as a captured image, and stores the image 50a as a captured image 100 as shown in FIG. 2C. By outputting, to the television receiver 4, the captured image 100 with the VBI portions 50b being removed as shown in FIG. 2C, it becomes possible to prevent the VBI portions 50b from being captured as noise in the captured image 100 to be displayed, whereby beautiful still images can be obtained.

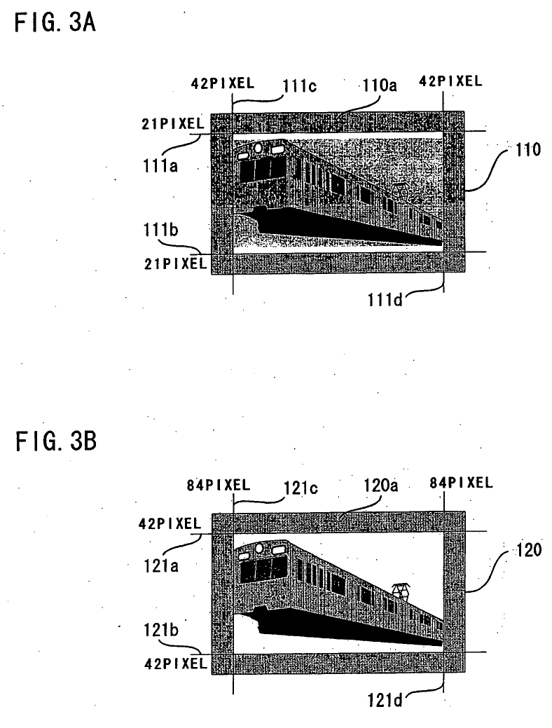

Next, the case of capturing video signals of digital broadcast will be described below with reference to FIG. 3A and FIG. 3B, wherein FIG. 3A shows a video signal in the case of 480 line resolution, while FIG. 3B shows a video signal in the case of 1080 line resolution. In some digital broadcasts as well, there are cases where television programs based on analog broadcast are digitally converted for broadcast. In such cases, there is a possibility that a video image 110 or 120 to be displayed contains VBI portions 110a or 120a of original television programs as images. Thus, captured images are stored by varying areas of images to be removed in accordance with or depending on the resolution. For example, in the case of 480 line resolution as shown in FIG. 3A, the top and bottom of the image 110, each for 21 pixels, are removed by cutting at horizontal lines 111a and 111b, respectively, while the left and right of the image 110, each for 42 pixels, are removed by cutting at vertical lines 111c and 111d, respectively, so as to capture the resultant image 110. On the other hand, in the case of 1080 line resolution as shown in FIG. 3B, the top and bottom of the image 120, each for 42 pixels, are removed by cutting at horizontal lines 121a and 121b, respectively, while the left and right of the image 120, each for 84 pixels, are removed by cutting at vertical lines 121c and 121d, respectively, so as to capture the resultant image 120.

As described above, the STB 1 stores a video image as a captured image by removing the VBI portions of the video image in accordance with the resolution of an image to be captured and with the kind of broadcast, and outputs the captured image to the television receiver 4 with the VBI portions being removed, so that the VBI portions are prevented from being captured in the captured image and displayed.

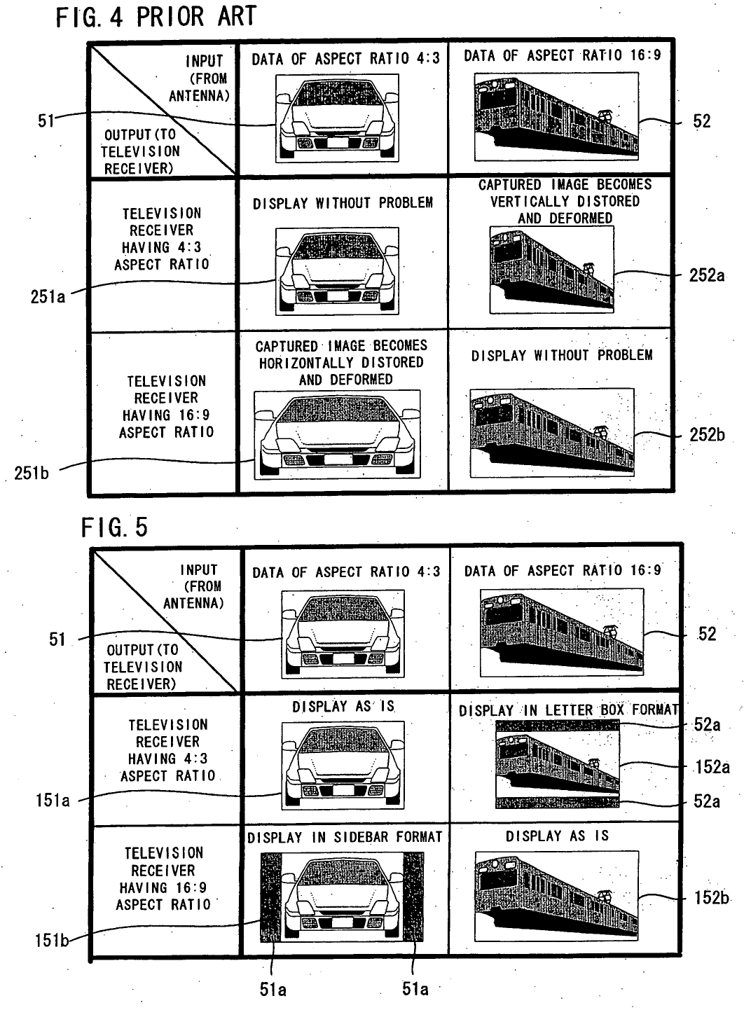

The following describes means for preventing the video image deformation of captured images due to the aspect ratio. In the case of digital broadcast, aspect ratio information is contained in streams of digital broadcast. However, in the case where such video images are stored as captured images, the aspect ratio information in the streams is lost. As shown in FIG. 4, when a conventional still image capture device stores, as a captured image, a video image 51 being input from an antenna and having a 4:3 aspect ratio, and outputs this captured image to a television receiver having a 4:3 aspect ratio, it can display the video image 51 without a problem as shown by a display screen 251a. However, when the conventional still image capture device outputs the captured image to a television receiver having a 16:9 aspect ratio, it results that the captured image becomes horizontally distorted and deformed as shown by a display screen 251b. Likewise, when the conventional still image capture device stores, as a captured image, a video image 52 being input from an antenna and having a 16:9 aspect ratio, and outputs this captured image to a television receiver having a 16:9 aspect ratio, it can display the video image 52 without a problem as shown by a display screen 252b. However, when the conventional still image capture device outputs the captured image to a television receiver having a 4:3 aspect ratio, it results that the captured image becomes vertically distorted and deformed as shown by a display screen 252a.

In contrast, when storing a captured image, the STB 1 according to the present embodiment stores aspect ratio information of the captured image together with the captured image. In the case where the captured image is to be output for display on the television receiver 4 with an aspect ratio different from the aspect ratio information, the STB 1 adds, to the captured image, blank portions 51a or 52a in accordance with the aspect ratio information as shown in FIG. 5 so as to prevent the deformation of the captured image.

More specifically, as shown in FIG. 5, in the case where the STB 1 stores, as a captured image, a video image 51 being input from an antenna and having a 4:3 aspect ratio, and outputs the captured image to the television receiver 4 having a 4:3 aspect ratio, the STB 1 displays the captured image, as is, as a display screen 151a on the television receiver 4 in a manner similar to the conventional still image capture device. However, in the case where the STB 1 outputs such captured image to the television receiver 4 having a 16:9 aspect ratio, the STB 1 adds blank portions 51a on both left and right sides of the captured image, and displays a display screen 151b on the television receiver 4 in sidebar format.

On the other hand, in the case where the STB 1 stores, as a captured image, a video image 52 being input from an antenna and having a 16:9 aspect ratio, and outputs the captured image to the television receiver 4 having a 16:9 aspect ratio, the STB 1 displays the captured image, as is, as a display screen 152b on the television receiver 4 in a manner similar to the conventional still image capture device. However, in the case where the STB 1 outputs such captured image to the television receiver 4 having a 4:3 aspect ratio, the STB 1 adds blank portions 52a on the top and bottom sides of the captured image, and displays a display screen 152a on the television receiver 4 in letter box format. Thus, the STB 1 can display each captured image without deforming the captured image, even if the aspect ratio information upon storing the captured image is different from the aspect ratio of the television receiver 4.

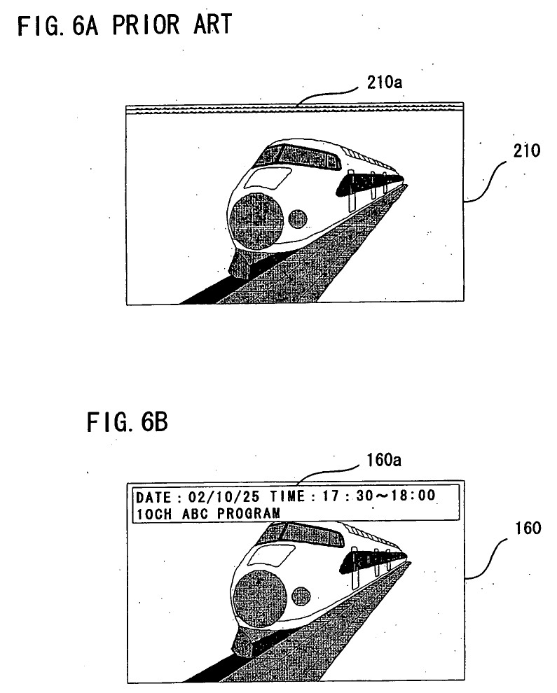

Next, referring to FIG. 6A and FIG. 6B, a still image capture device as well as a digital/analog tuner device comprising the same according to a second embodiment of the present invention will be described. The still image capture device and the digital/analog tuner device (STB 1) comprising the same according to the second embodiment are basically the same as those according to the first embodiment, except that the still image capture device or STB 1 of the second embodiment does not remove the VBI portions of each video signal when storing each video signal as a captured image, and that it stores EPG information for the captured image together with the captured image, wherein the EPG information is such as channel number, date/time (or program broadcast time) of capture and short name. Since each captured image is stored without removing the VBI portions, a problem arises if the captured image is displayed, as is, on the display screen of the television receiver 4 such that as shown in FIG. 6A, the VBI portions are displayed on the display screen 210 as noise 210a similarly as in the conventional still image capture device.

In contrast, as shown in FIG. 6B, when outputting the captured image to the television receiver 4, the STB 1 (more specifically the output unit 13) superimposes EPG information 160a on the captured image for output so as to hide the VBI portions contained in the video signal (namely the STB 1 superimposes EPG information 160a on the VBI portions), and displays a display screen 160 on the television receiver 4. Accordingly, the VBI portions are not displayed as the noise 210a. Furthermore, since the EPG information 160a for the captured image is output together with the captured image, it becomes possible to easily identify which program has been captured. In addition, it becomes possible to use the EPG information as a slide show function such that by specifying a condition such as title of program using the EPG information, only captured images corresponding to the specified condition are displayed as a slide show.

It is to be noted that the present invention is not limited to the above embodiments, and various modifications are possible. For example, although the STB 1 has been described in the above embodiments as an example of a digital/analog tuner device, it is possible to integrally incorporate a digital/analog tuner device in the television receiver 4.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

1. A still image capture device to store, as a captured image, a video signal for one frame input thereto,
wherein when storing the captured image, the still image capture device removes VBI (Vertical Blanking Interval) portions of the video signal in accordance with resolution and kind of broadcast of the video signal.

2. A digital/analog tuner device comprising the still image capture device according to claim 1 and further comprising:
a receiving means for receiving digital/analog broadcast signals;
a decoder for extracting video signals from the digital/analog broadcast signals received by the receiving means, in which the still image capture device stores, as the captured image, a video signal for one frame extracted by the decoder; and
an output means for outputting, to a display means, the video signal extracted by the decoder and the captured image stored by the still image capture device,
wherein when storing the captured image, the still image capture device stores aspect ratio information of the captured image,
wherein when outputting the captured image to the display means, the output means outputs the captured image with the VBI portions being removed, and
wherein in the case where the captured image is displayed on the display means with an aspect ratio different from the aspect ratio information, the output means adds, to the captured image for output, blank portions corresponding to the aspect ratio information so as to prevent deformation of the captured image.

3. A digital/analog tuner device comprising:
a receiving means for receiving digital/analog broadcast signals;
a decoder for extracting video signals from the digital/analog broadcast signals received by the receiving means;
a still image capture device to store, as a captured image, a video signal for one frame extracted by the decoder; and
an output means for outputting, to a display means, the video signal extracted by the decoder and the captured image stored by the still image capture device,
wherein when storing the captured image, the still image capture device stores aspect ratio information of the captured image together with the captured image,
wherein when outputting the captured image to the display means in the case where the captured image is displayed on the display means with an aspect ratio different from the aspect ratio information, the output means adds, to the captured image for output, blank portions corresponding to the aspect ratio information so as to prevent deformation of the captured image.

4. A digital/analog tuner device comprising:
a receiving means for receiving digital/analog broadcast signals;
a decoder for extracting video signals and EPG (Electronic Program Guide) information from the digital/analog broadcast signals received by the receiving means;
a still image capture device to store, as a captured image, a video signal for one frame extracted by the decoder; and
an output means for outputting, to a display means, the video signal extracted by the decoder and the captured image stored by the still image capture device,
wherein when storing the captured image, the still image capture device stores the EPG information for the captured image together with the captured image, and
wherein when outputting the captured image to the display means, the output means superimposes the EPG information on the captured image for output so as to hide VBI portions contained in the video signal.
